(19) United States
(12) Patent Application Publication
(10) Pub. No.: US 2026/0366538 A1
(43) Pub. Date: Nov. 19, 2026

(54) MODULAR BLADE QUICK ASSEMBLY COMPONENT AND OPEN-LEAF FAN WITH REDUNDANT SELF-LOCKING AND ANTI-DETACHMENT

(71) Applicant: Guangdong Wanju Lighting Technology Co., Ltd., Shongshan (CN)

(72) Inventor: XIAOXIANG YANG, Zhongshan (CN)

(21) Appl. No.: 19/750,538

(22) Filed: Jul. 22, 2026

(51) Int. Cl. F04D 29/64; F04D 25/08; F21V 33/00

(52) U.S. Cl. CPC F04D 29/646; F04D 25/088; F21V 33/0096

(57) ABSTRACT

Provided are a modular fan blade quick assembly component and an open-leaf fan with redundant self-locking and anti-detachment. The quick installation component includes fan blades and plug-in sockets, with anti-detachment plug-in parts, anti-detachment grooves, guide inclined surfaces, and positioning grooves at ends of the fan blades; the plug-in sockets are provided with double-sided rotatable locking blocks and elastic components. The locking blocks have a buckle end and an external pull rod part, and the anti-detachment grooves achieve reverse self-locking. The plug-in sockets are provided with positioning protrusions, out-pull elastic sheets, and curved compression plates. It adopts a split-type of a seat body and a bottom plate, with threaded screws serving as rotating shafts of locking blocks. The top is provided with an installation connection seat. The open-leaf fan includes a support body, a rotating seat, the quick installation components, a motor, and a lighting assembly.

### TECHNICAL FIELD

The present disclosure relates to the field of fan technologies, and in particular, to a modular blade quick assembly component and an open-leaf fan with redundant self-locking and anti-detachment.

### BACKGROUND

With the development of home appliances, open-leaf fans (including hidden fans and ceiling fans) are widely used in home and commercial spaces due to their dual functions of ventilation and lighting. To improve the assembly and maintenance efficiency of fan blades and reduce production and manufacturing costs, existing open-leaf fans mostly adopt quick installation fan blade installation structures. However, there are still many technical defects that are difficult to overcome in practical applications of the existing quick installation structures, as follows.
1. Insufficient anti-detachment safety and no redundant protection design. The existing quick release structures mostly adopt single-point locking or single-sided buckle structures and only use a single locking component to fix the fan blades. When the locking component fails elastically, wears and breaks, or deforms under centrifugal force, it is easy to cause locking failure, resulting in the fan blades being dislodged by centrifugal force during high-speed rotation, which poses a serious personal safety hazard. At the same time, most of the existing locking structures are positively clamped, and when the fan blades are subjected to external tension or centrifugal force, the locking components are easily dislodged by reverse force, rendering it impossible to achieve self-locking and anti-detachment, and the reliability of anti-detachment is extremely poor.
2. High structural coupling, poor universality, and high manufacturing cost. The existing fan blade quick installation structures are mostly integrated with the rotating seat and fan blade frame of the open-leaf fan, and the locking mechanism is integrated inside the blade frame. Open-leaf fans with different appearance specifications and sizes require separate mold customization to adapt to the quick installation structure, which cannot achieve modular universal adaptation, resulting in high mold costs, long production cycles, inability to be compatible with different materials and specifications of blade blades, and poor mass production adaptability.
3. Poor assembly stability, prone to shaking and abnormal noise problems. To ensure smooth disassembly and assembly, existing quick installation structures generally reserve assembly gaps between the fan blades and the installation seat. However, during the high-speed rotation of the open-leaf fan, this gap can cause radial and axial shaking of the fan blades, which not only produces continuous operating noise but also exacerbates the wear and tear of the locking structure, further reducing the reliability of the locking mechanism; at the same time, the existing structure lacks precise guidance and positioning, which makes it easy for the fan blades to deviate during assembly, resulting in large deviations in the dynamic balance of each blade and exacerbating operational shaking.
4. The disassembly and assembly operation is inconvenient, and the maintenance difficulty is high. The unlocking mechanism of the existing quick installation structure is mostly hidden inside the rotating seat. After the open blade is lifted from the ceiling, it is not convenient to disassemble and maintain the fan blades. Some structures require special tools to unlock and disassemble, which is cumbersome to operate. At the same time, after unlocking the existing structure, there is no auxiliary exit structure, and the fan blades are prone to jamming and cannot be quickly removed, resulting in low maintenance efficiency.

### SUMMARY

The present disclosure provides a modular blade quick assembly component and an open-leaf fan with redundant self-locking and anti-detachment, which can solve problems of insufficient safety, poor universality, poor assembly stability, and difficult maintenance of the existing quick installation fan blade installation structure of open-leaf fans.

To achieve the above objectives, in a first aspect, the present disclosure provides the following technical solution: a modular fan blade quick assembly component with redundant self-locking and anti-detachment, including: fan blades and plug-in sockets, where one end of each of the fan blades is provided with an anti-detachment plug-in part configured to insert into one corresponding the plug-in socket, and edges of two sides of the anti-detachment plug-in part are provided with anti-detachment grooves; interiors of the plug-in sockets that are provided on two sides of the anti-detachment plug-in part are provided with locking blocks that are horizontally rotatable; when the anti-detachment plug-in part is inserted into the plug-in sockets from an outside, the locking blocks are be pushed to rotate in a first direction; the locking blocks are provided with elastic components configured to drive the locking blocks to rotate in a second direction; when the anti-detachment plug-in part is inserted into an extreme position and the locking blocks rotate in the second direction, a buckle end provided at one end of the locking blocks is embedded into the corresponding anti-detachment groove.

In some embodiments of the present disclosure, another end of the locking blocks is provided with a pull rod part that is configured to extend to outsides of the plug-in sockets.

In some embodiments of the present disclosure, each of the anti-detachment grooves include a curved side wall and an inclined side wall that are arranged in a V-shape, a circular arc surface of an end of the buckle end is adjacent to the curved side wall, and an adjacent side wall of the buckle end is in contact with the inclined side wall.

In some embodiments of the present disclosure, an angle between the inclined side wall and two side walls of the anti-detachment plug-in part is 30 degrees.

In some embodiments of the present disclosure, a radius of the curved side wall is 14 mm.

In some embodiments of the present disclosure, guide inclined surfaces are provided at corners of two sides of an end of the anti-detachment plug-in part, and when the anti-detachment plug-in part is inserted into the plug-in sockets, the guide inclined surfaces push the locking blocks to rotate in the first direction.

In some embodiments of the present disclosure, the end of the anti-detachment plug-in part is centrally provided with a positioning groove, and interiors of the plug-in sockets are provided with a positioning protrusion that is embedded with the positioning groove.

In some embodiments of the present disclosure, inner side walls of the plug-in sockets that are on two sides of the positioning protrusion are provided with out-pull elastic sheets, and the out-pull elastic sheets push the fan blades outward after the locking blocks are disengaged from the anti-detachment grooves.

In some embodiments of the present disclosure, each of the plug-in sockets includes a bottom plate and a seat body that is arranged on an upper side of the bottom plate, the bottom plate and the seat body are connected by multiple threading screws, and middle of the locking blocks are provided with the threading screws as rotating shafts.

In some embodiments of the present disclosure, a top of the seat body is provided with multiple curved compression plates that are downward protruding, and the anti-detachment plug-in part contacts the curved compression plates when inserted into the plug-in sockets.

In some embodiments of the present disclosure, an upper side of each of the plug-in sockets is provided with an installation connection base, and a top of the installation connection base is provided with multiple installation screws.

In a second aspect, the present disclosure further provides an open-leaf fan, including a support body and multiple modular fan blade quick assembly components, where a motor component is provided inside the support body, a lower end of the motor component is connected to a rotating seat; the plug-in sockets in the modular fan blade quick assembly components are provided in the rotating seat through the installation connection base, and the fan blades extend diagonally from a side wall of the rotating seat.

In some embodiments of the present disclosure, a lower end of the rotating seat is provided with a lighting component.

Compared with the existing technology, the beneficial effects of the present disclosure are as follows.

Adopting a new anti-detachment structure, the anti-detachment plug-in part can push the locking blocks to rotate in the first direction to yield when inserted, without the need for manual unlocking, thereby achieving automatic yielding upon insertion, greatly simplifying assembly operations, and achieving quick one handed insertion and installation; at the same time, this matching structure allows the assembly process to be completed without the need for additional tools, only by axial pushing, which is suitable for on-site assembly scenarios after ceiling lifting; the reset force of the elastic components is adapted to the rotation direction of the locking blocks. When the anti-detachment plug-in part is inserted into place, the elastic component can instantly drive the locking blocks to rotate and reset in the second direction, so that the buckle end is automatically inserted into the anti-detachment grooves, realizing the blind installation operation of “pushing in and locking”, without the need for manual alignment and locking, improving assembly efficiency and consistency; and the double-sided locking blocks are synchronously embedded in the corresponding anti-detachment groove, thereby forming a symmetrical two-point locking structure, so that the forces on two sides of the anti-detachment plug-in part are completely balanced, avoiding the problems of blade deflection and force concentration caused by single-sided locking, and greatly improving the anti-fatigue strength and anti-centrifugal force performance of the locking structure; when the fan blades are subjected to outward tension or high-speed centrifugal force, the anti-detachment grooves will apply an outward axial force to the buckle end, which can be converted into a torque that drives the locking blocks to rotate in the second direction, rendering the buckle end more tightly fitted with the anti-detachment grooves, thus forming a reverse self-locking effect of “tightening with pulling”. This solves the industry pain point of locking failure caused by centrifugal force from a mechanical principle and has inherent anti-detachment performance.

### BRIEF DESCRIPTION OF THE DRAWINGS

FIG. 1 is an overall three-dimensional diagram of a modular fan blade quick assembly component provided by the present disclosure.

FIG. 2 is a sectional structural diagram of the modular fan blade quick assembly component provided by the present disclosure.

FIG. 3 is a three-dimensional diagram of a plug-in socket provided by the present disclosure.

FIG. 4 is a structural diagram of a locking block provided by the present disclosure.

FIG. 5 is a schematic diagram of a locking state of the modular fan blade quick assembly component provided by the present disclosure.

FIG. 6 is a schematic diagram of an unlocked state of the modular fan blade quick assembly component provided by the present disclosure.

FIG. 7 is a three-dimensional structural diagram of an open-leaf fan provided by the present disclosure.

FIG. 8 is a sectional structural diagram of the open-leaf fan provided by the present disclosure.

FIG. 9 is an internal structural diagram of the open-leaf fan provided by the present disclosure.

Numeral reference: 1—modular fan blade quick assembly component, 2—support body, 3—rotating seat, 4—motor component, 5—lighting component, 11—fan blades, 111—anti-detachment plug-in part, 112—guide inclined surface, 113—positioning groove, 114—anti-detachment groove, 115—curved side wall, 116—inclined side wall, 12—locking block, 121—buckle end, 122—pull rod part, 13—installation connection base, 131—installation screw, 14—plug-in socket, 141—seat body, 142—bottom plate, 143—elastic component, 144—curved compression plate, 145—positioning protrusion, 146—out-pull elastic sheet, 15—threading screw.

### DESCRIPTION OF EMBODIMENTS

Below the technical solutions in the embodiments of the present disclosure will be clearly and completely described in combination with the accompanying drawings.

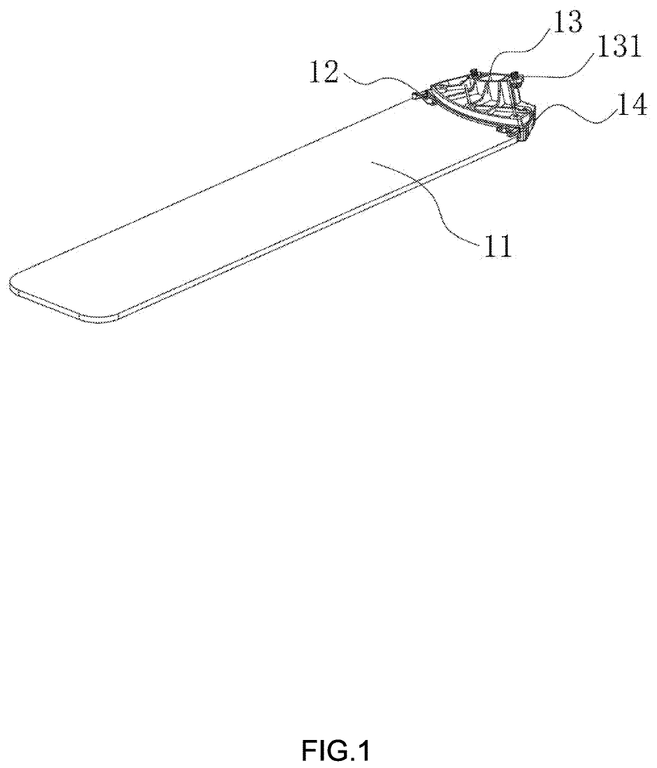

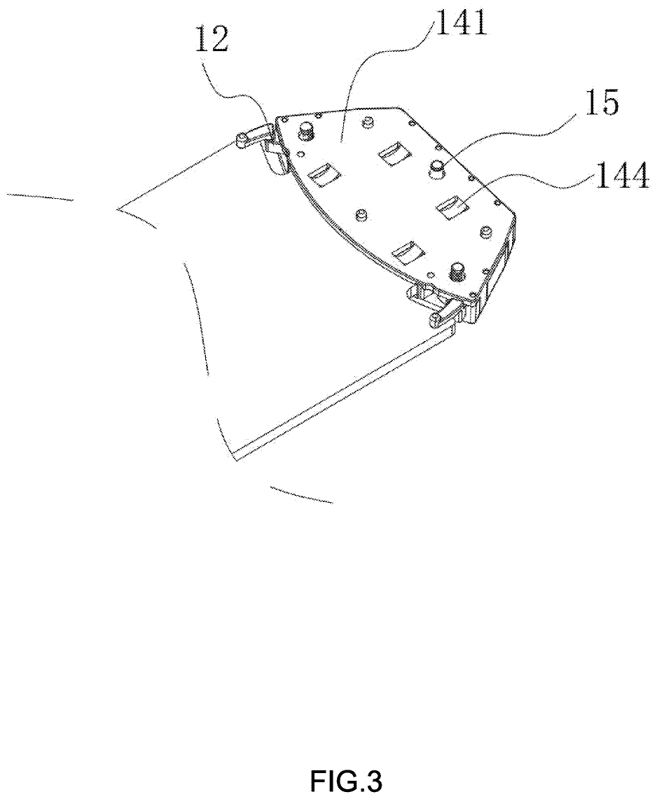

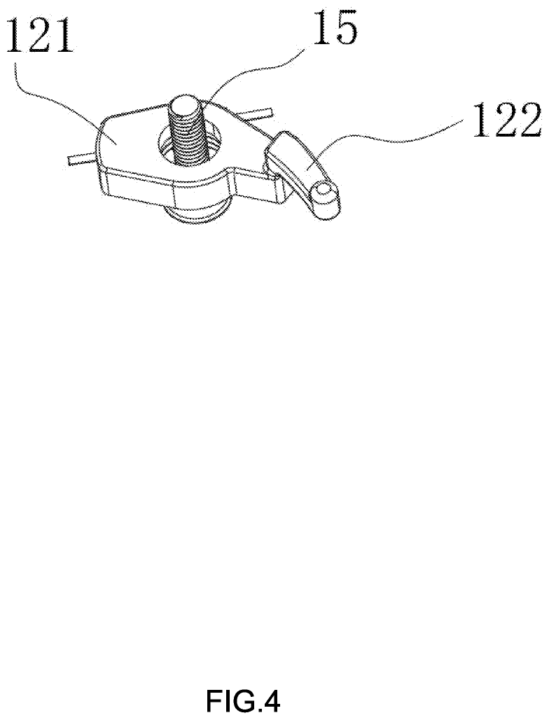

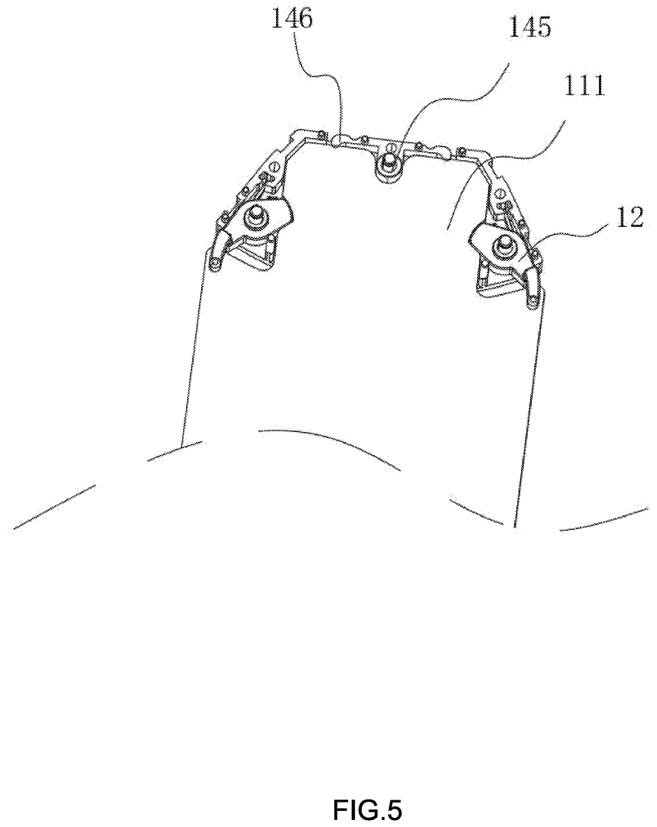

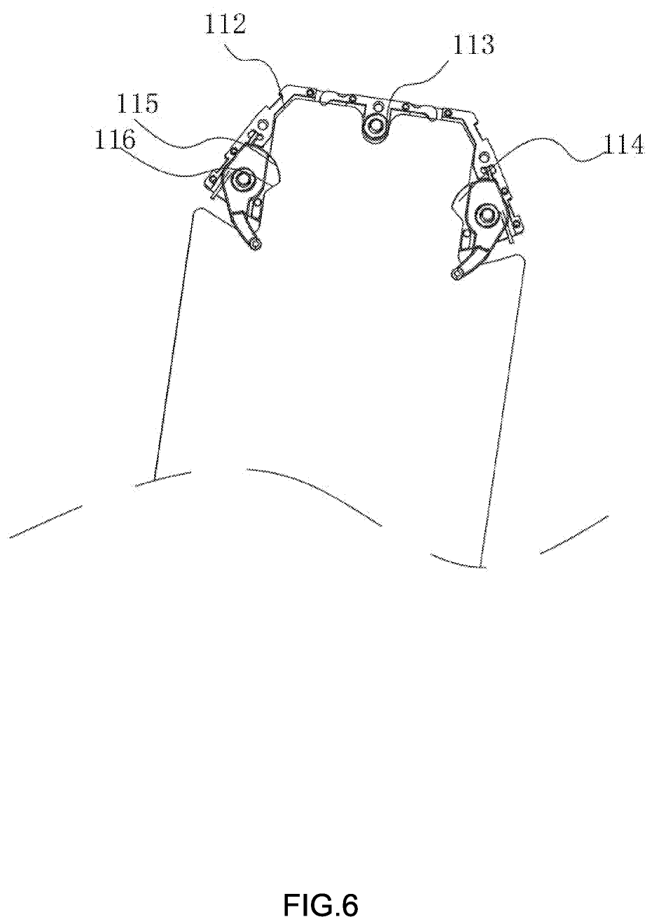

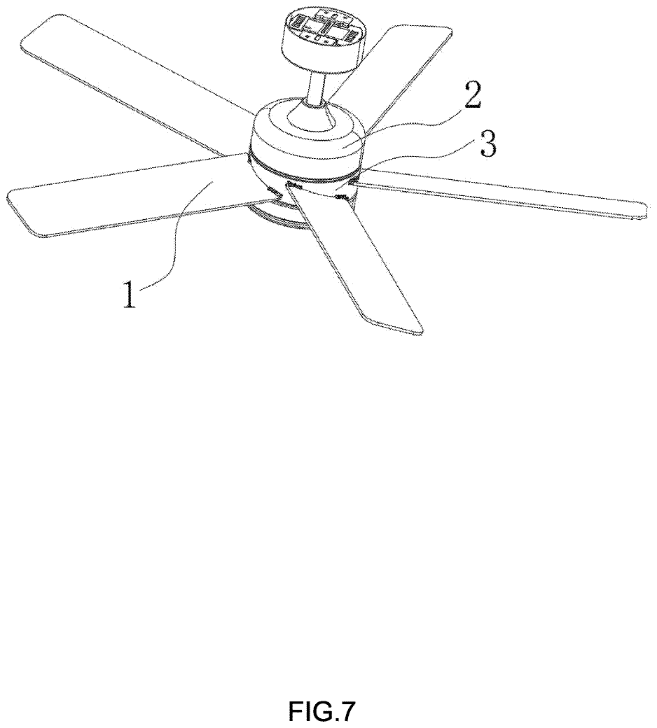

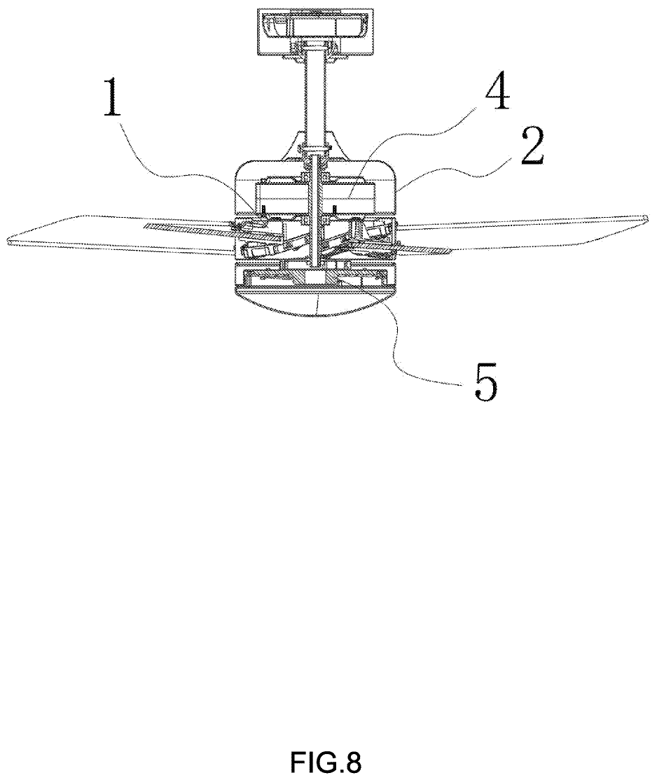

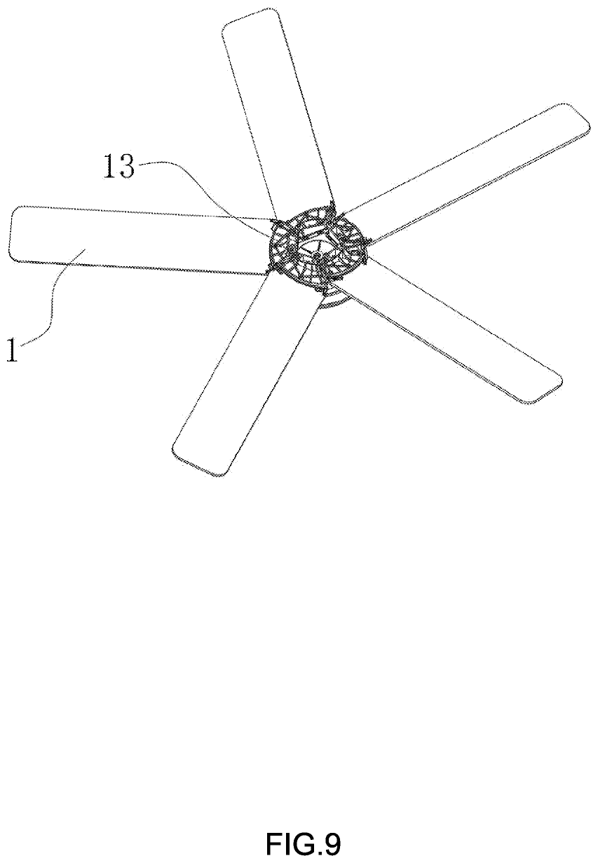

As shown in FIGS. 1-9, the present disclosure provides the following technical solution to solve problems of insufficient safety, poor universality, poor assembly stability, and difficult maintenance of the existing quick installation fan blade installation structure of an open-leaf fan: a modular fan blade quick assembly component with redundant self-locking and anti-detachment, including fan blades 11 and plug-in sockets 14. One end of each of the fan blades 11 is provided with an anti-detachment plug-in part 111 configured to insert into the plug-in sockets 14, and two side edges of the anti-detachment plug-in part 111 are provided with anti-detachment grooves 114. Interiors of the plug-in sockets 14 that are located on two sides of the anti-detachment plug-in part 111 are provided with horizontally rotatable locking blocks 12. When the anti-detachment plug-in part 111 is inserted into the plug-in sockets 14 from an outside, locking blocks 12 can be pushed to rotate in a first direction. The locking blocks 12 is provided with elastic components 143 configured to drive the locking blocks 12 to rotate in a second direction, when the anti-detachment plug-in part 111 is inserted to an extreme position, the locking blocks 12 rotate in the second direction, and the buckle end 121 provided at one end of the locking blocks 12 is embedded into a corresponding anti-detachment groove 114.

Where the anti-detachment plug-in part 111 serves as a docking carrier between the fan blades 11 and the plug-in sockets 14, integrating a locking fitting structure at ends of the fan blades 11 without the need for additional installation structures on the fan blade bodies, ensuring the structural integrity of the fan blades 11. At the same time, through standardized anti-detachment plug-in part design, it can adapt to the plug-in sockets 14 with different specifications, thereby improving the universality of components. The locking blocks 12 adopt a horizontally rotating structural design. Compared with the axial sliding buckle structure, the rotating locking has a shorter stroke, faster locking response, and the direction of the horizontal rotation force is adapted to the centrifugal force direction of the fan blades 11, which can convert a centrifugal force into a locking force instead of disengagement force; at the same time, the locking blocks 12 independently provided on two sides form a dual point redundant locking structure. When any locking block 12 fails, the other locking block 12 can still complete the locking and anti-detachment, thus fundamentally solving the safety hazard of single-point locking failure.

The elastic components 143 can use a coil spring to provide a continuous reset driving force for the locking blocks 12, ensuring that the locking blocks 12 always maintain a tendency to rotate in a locking direction when there is no external force pushing, ensuring that after the anti-detachment plug-in part 111 is in place, the buckle end 121 can automatically embed into the anti-detachment grooves 114, thereby achieving tool free automatic locking and improving assembly efficiency; at the same time, a pre-tightening force of the elastic components 143 can offset the assembly gap of the locking blocks 12, thus avoiding locking failure caused by the shaking of the locking blocks 12.

The fan blades 11 are integrally formed with the anti-detachment plug-in part 111. The anti-detachment plug-in part 111 is a flat insertion structure, and its width is adapted to an insertion opening width of the plug-in sockets 14. Left and right edges of the anti-detachment plug-in part 111 are symmetrically provided with concave anti-detachment grooves 114. The plug-in sockets 14 are hollow cavity structures, with an opening at its front end configured for the anti-detachment plug-in part 111 to insert. In an inner cavity of each of the plug-in sockets 14, located on the left and right sides of insertion paths of the anti-detachment plug-in part 111, there are two symmetrical locking blocks 12 that can rotate in a horizontal plane. Rotation center axes of the two locking blocks 12 are parallel to each other and perpendicular to the insertion direction of the plug-in sockets 14.

Each locking block 12 is provided with elastic components 143, in this embodiment, the elastic components 143 use a torsion spring. One end of the torsion spring is in contact with the locking blocks 12, and the other end of the torsion spring is in contact with an inner wall of the plug-in sockets 14. A pre-tightening force of the torsion spring drives the locking blocks 12 to always rotate in the second direction towards the central axis of the plug-in sockets 14, that is, in a locking direction. One end of each of the locking blocks 12 facing the insertion opening is provided with a buckle end 121, and the buckle end 121 is a block shaped structure protruding towards the center of the plug-in sockets 14.

When the anti-detachment plug-in part 111 is inserted outward from the opening of the plug-in sockets 14, a front end of the anti-detachment plug-in part 111 first contacts inner edges of the two locking blocks 12, thereby pushing the two locking blocks 12 to rotate in the first direction (i.e., towards a direction away from the central axis of the plug-in sockets 14, i.e., a direction of yielding) to make way for the insertion of the anti-detachment plug-in part 111; when the anti-detachment plug-in part 111 is inserted to the extreme position, the anti-detachment grooves 114 are aligned with the buckle end 121 of the locking blocks 12. At this time, the torsion spring drives the locking blocks 12 to rotate and reset in the second direction, and the buckle end 121 automatically inserts into the corresponding anti-detachment grooves 114, thereby completing the automatic locking and fixing of the fan blades 11.

In this embodiment, the first direction and the second direction are opposite rotation directions, and the first direction of a left locking block 12 rotates counterclockwise, and the second direction rotates clockwise; the first direction of a right locking block 12 rotates clockwise, and the second direction rotates counterclockwise, ensuring that the two locking blocks 12 lock synchronously towards the center and give way to the outer side.

In this embodiment, another end of each of the locking blocks 12 is provided with a pull rod part 122 extending to the outside of the plug-in sockets 14. The pull rod part 122 is integrally formed with the locking blocks 12 and is located at the other end of each of the locking blocks 12 away from the buckle end 121. Based on the lever principle, the rotational force arm of the pull rod part 122 is greater than that of the buckle end 121. A user only needs to apply a small pinching force to drive the locking blocks 12 to overcome the pre-tightening force of the elastic components 143 and rotate, greatly reducing the force requirements for unlocking operation and improving operational convenience. The pull rod part 122 extends outward from the plug-in sockets 14, and side walls of the plug-in sockets 14 is provided with avoidance grooves for the pull rod part 122 to move. The stroke of the avoidance grooves is adapted to the rotation stroke of the locking blocks 12, which not only ensures that the pull rod part 122 can smoothly drive the locking blocks 12 to rotate and unlock, but also limits the rotation stroke of the pull rod part 122 through the ends of the avoidance grooves. Specifically, in this embodiment, each locking block 12 is integrally formed with a pull rod part 122 at one end away from the buckle end 121, and the pull rod part 122 extends radially outward along the rotation of the locking blocks 12. On the left and right side walls of the plug-in sockets 14, there are corresponding elongated avoidance grooves that extend along a direction of a rotation trajectory of the locking blocks 12. The pull rod part 122 extends through the avoidance groove to the outside of the plug-in sockets 14, and can move back and forth along the rotation direction of the locking blocks 12 in the avoidance groove. When it is necessary to disassemble the fan blades 11, the user only needs to pinch the two pull rod parts 122 extending from the outside of the plug-in sockets 14 by hand, so that the two pull rod parts 122 are close to each other, and can drive the two locking blocks 12 to rotate in the first direction (yielding direction), so that the buckle end 121 can be released from the anti-detachment grooves 114, thereby completing the unlocking. At this time, the fan blades 11 can be directly extracted from the plug-in sockets 14 without the need for any tools and can be operated with one hand. Two ends of the avoidance grooves correspond to a locking limit position and an unlocking limit position of the locking blocks 12, respectively. When the pull rod part 122 is in contact with the ends of the avoidance grooves, the locking blocks 12 cannot continue to rotate, avoiding excessive rotation and causing plastic deformation failure of the torsion spring.

In this embodiment, each of the anti-detachment grooves 114 includes a curved side wall 115 and an inclined side wall 116 that are arranged in a V-shape. A circular arc surface of an end of the buckle end 121 is adjacent to the curved side wall 115, and an adjacent side wall of the buckle end 121 is in contact with the inclined side wall 116; in an implementation mode, a fit between the curved side wall 115 and a circular arc surface of the buckle end 121 is a surface contact, rather than a line contact or point contact. When the fan blades 11 rotate at high speed and are subjected to centrifugal force, the stress on the contact surface is evenly distributed, which can greatly improve the impact load resistance of the structure. The inclination direction of the inclined side wall 116 is adapted to the rotation direction of the locking blocks 12. When the fan blades 11 are subjected to an outward axial tension, the contact force of the inclined side wall 116 on the buckle end 121 will generate a force that drives the locking blocks 12 to rotate in the locking direction, rendering the contact between the buckle end 121 and the inclined side wall 116 tighter, achieving reverse self-locking, and completely eliminating the problem of the buckle end 121 being pulled out by an axial force; at the same time, this contact fit can eliminate an axial clearance between the buckle end 121 and the anti-detachment grooves 114, thereby avoiding axial movement of the fan blades 11 and fundamentally solving the problems of shaking and abnormal noise caused by assembly clearance. Where an angle between the inclined side wall 116 and the two side walls of the anti-detachment plug-in part 111 is 30 degrees, and a radius of the curved side wall 115 is 14 mm. The 30 degrees inclination angle is an optimal angle optimized through mechanical simulation and actual testing. This angle not only ensures sufficient self-locking force, but also efficiently converts axial tension into locking rotation torque, avoids the problems of difficult insertion of the buckle end 121 and excessive unlocking resistance caused by excessive inclination angle, and avoids problems of insufficient self-locking effect and easy detachment caused by too small inclination angle. When the fan blades 11 are subjected to an axial tension of 1000 N (far exceeding the maximum centrifugal force at a rated speed of the open-leaf fan), a locking rotational torque greater than 50 N·m can be generated, fully meeting the mechanical requirements for anti-detachment and self-locking. At the same time, the resistance of the buckle end 121 embedded in the anti-detachment grooves 114 at this angle is less than 5 N, ensuring that the elastic components 143 can smoothly drive the buckle end 121 to automatically embed and lock. The gripping force during unlocking is less than 10 N, and it can be easily operated with one hand, balancing the reliability of self-locking and the convenience of operation.

In this embodiment, guide inclined surfaces 112 are provided at corners on two sides of an end of the anti-detachment plug-in part 111. When the anti-detachment plug-in part 111 is inserted into the plug-in sockets 14, the guide inclined surfaces 112 push the locking blocks 12 to rotate in the first direction. The guide inclined surfaces 112 can be arranged at a 45 degrees angle. When the anti-detachment plug-in part 111 is inserted into the plug-in sockets 14, two guide inclined surfaces 112 first contact inner edges of the left and right locking blocks 12, respectively. As the anti-detachment plug-in part 111 is pushed in an axial direction, the guide inclined surfaces 112 convert the axial insertion force into radial thrust, the two locking blocks 12 are pushed to rotate outward to make way. Without manual unlocking, the smooth insertion of the anti-detachment plug-in part 111 can be completed. After the anti-detachment plug-in part 111 is inserted into place, the locking blocks 12 automatically reset and lock, thus achieving fully automatic assembly with push in locking.

In this embodiment, the end of the anti-detachment plug-in part 111 is centrally provided with a positioning groove 113, and an interior of each of the plug-in sockets 14 is provided with a positioning protrusion 145 that is embedded with the positioning groove 113. After the two are fitted together, the left and right radial displacement of the anti-detachment plug-in part 111 can be completely restricted, ensuring that the anti-detachment plug-in part 111 is always in the center position of the plug-in seat after insertion, so that the distance between the anti-detachment grooves 114 on the left and right sides and the buckle ends 121 of the two locking blocks 12 is completely consistent, ensuring that the two buckled ends can be synchronously embedded in the anti-detachment grooves 114, avoiding the problem of one side being locking and one side being not locking.

In this embodiment, a concave positioning groove 113 is provided at a center position of an end face of an insertion front end of the anti-detachment plug-in part 111, and the positioning groove 113 extends along the insertion axis of the anti-detachment plug-in part 111. A cross-section of the positioning groove 113 is rectangular, and it can also adopt suitable shapes such as trapezoidal, semi-circular, etc. A rear end of the inner cavity of each of the plug-in sockets 14, which is directly opposite to an insertion direction of the anti-detachment plug-in part 111, is integrally formed with a forward protruding positioning protrusion 145. Outer dimensions of the positioning protrusion 145 are adapted to an inner cavity dimension of the positioning groove 113, and the two are clearance fit, with a fit gap of 0.1-0.2 mm.

In this embodiment, inner side walls of the plug-in sockets 14 provided on two sides of the positioning protrusion 145 are provided with out-pull elastic sheets 146. After the locking blocks 12 are disengaged from the anti-detachment grooves 114, the out-pull elastic sheets 146 push the fan blades 11 outward. When the anti-detachment plug-in part 111 is inserted into the plug-in sockets 14, the front end face of the anti-detachment plug-in part 111 will compress the out-pull elastic sheets 146, causing elastic deformation of the out-pull elastic sheets 146 and storing elastic potential energy; when the locking blocks 12 are locked, the elastic force of the out-pull elastic sheets 146 will continue to apply outward thrust to the anti-detachment plug-in part 111, so that the inclined side wall 116 of the anti-detachment grooves 114 always closely contacts the adjacent side wall of the buckle end 121, eliminating axial assembly clearance, further avoiding axial movement and abnormal noise of the fan blades 11, and strengthening the self-locking effect. When the user pinches the pull rod part 122 to unlock the locking blocks 12, the buckle end 121 is released from the anti-detachment grooves 114, and the elastic potential energy stored in the out-pull elastic sheets 146 are instantly released. The anti-detachment plug-in part 111 is automatically pushed outward for a distance, so that the anti-detachment grooves 114 are completely misaligned with the buckle end 121, avoiding the buckle end 121 from being embedded in the anti-detachment grooves 114 again after the user releases the pull rod part 122, ensuring the effectiveness of unlocking; at the same time, the automatic ejection of the out-pull elastic sheets 146 do not require the user to manually pull the fan blades 11 outward. Simply pinch the pull rod part 122 with one hand to unlock and automatically eject, greatly improving the convenience of disassembly operations, especially suitable for disassembly scenarios after high-altitude lifting. In an implementation mode, the out-pull elastic sheets 146 are integrally formed with the plug-in sockets 14, with one end fixedly connected to a side wall of an inner cavity of the plug-in sockets 14 and the other end being a free end that is protruding forward.

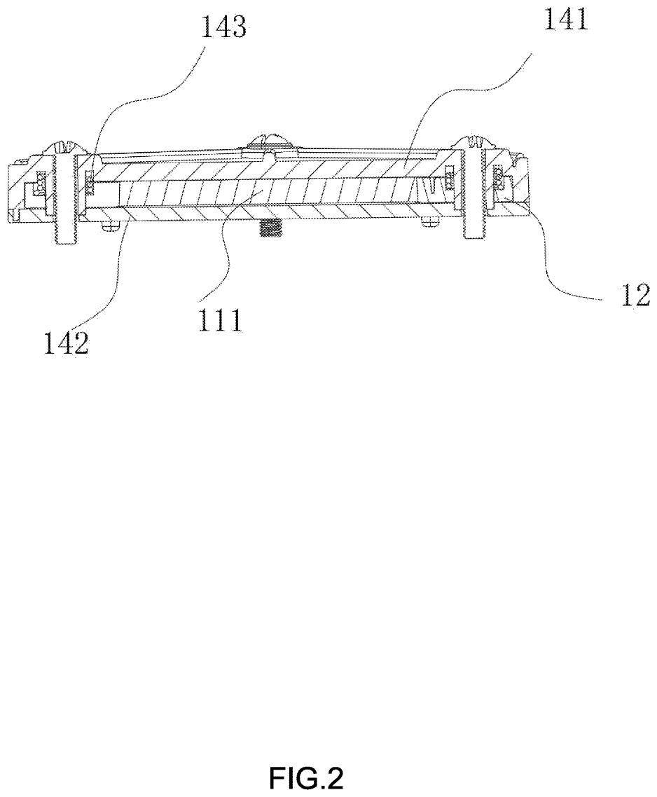

As a specific structure of the plug-in sockets 14, as shown in FIG. 2, each of the plug-in sockets 14 includes a bottom plate 142 and a seat body 141 that is arranged on an upper side of the bottom plate 142. The bottom plate 142 and the seat body 141 are connected by multiple threading screws 15, and middles of the locking blocks 12 are provided with the threading screws 15 as rotating shafts. A split structure can realize the pre installation of internal parts. First, the locking blocks 12, the elastic components 143, the out-pull elastic sheets 146 and other parts are assembled into the inner cavity of the seat body 141, and then the bottom plate 142 is fastened to the seat body 141 through the threading screws 15. The assembly process is unobstructed, easy to operate, and suitable for automated mass production assembly, which can greatly improve assembly efficiency and product yield. The two threading screws 15 are provided on the left and right sides of the plug-in sockets 14, serving as the rotation shafts for the two locking blocks 12. A circular shaft hole is provided in middles of the locking blocks 12, the threading screws 15 pass through the shaft hole. A lower end is securely connected to a threaded hole of the bottom plate 142, and an upper end is securely connected to a threaded hole of the seat body 141. The locking blocks 12 can smoothly rotate around the threading screws 15 in a horizontal plane. When assembling, the torsion spring is first placed on an outer side of the shaft hole of the locking blocks 12, the two locking blocks 12 are placed into the corresponding installation positions in the inner cavity of the seat body 141, then the out-pull elastic sheets 146 and the positioning protrusion 145 are assembled in place, and then the bottom plate 142 is aligned with the seat body 141. The threading screws 15 are threaded and it is tightened to complete the preassembly of the entire quick assembly component, thereby forming an independent modular component. The assembly process is simple and suitable for automated mass production.

In this embodiment, a top of the seat body 141 is provided with multiple downward protruding curved compression plates 144. When the anti-detachment plug-in part 111 is inserted into the plug-in sockets 14, it contacts the curved compression plates 144. When the anti-detachment plug-in part 111 is inserted into the plug-in sockets 14, the curved compression plates 144 are lifted upward by the anti-detachment plug-in part 111, generating elastic deformation and applying continuous downward elastic compression force to the anti-detachment plug-in part 111, so that a lower surface of the anti-detachment plug-in part 111 is closely adhered to an upper surface of the bottom plate 142, thereby eliminating the upper and lower assembly gaps of the anti-detachment plug-in part 111, avoiding the occurrence of up and down movements and shaking of the fan blades 11 when rotating at high speed, fundamentally solving the problem of abnormal operation caused by the upper and lower gaps. At the same time, the elastic compression force of the curved compression plates 144 can adapt to anti-detachment plug-in parts 111 of different thicknesses, improving the universality of the component and being compatible with fan blades 11 of different thickness specifications.

At the same time, the curved compression plates 144 adopt an arc-shaped structure, with an upward curved guide surface at its front end. When the anti-detachment plug-in part 111 is inserted, it can smoothly slide into the lower part of the curved compression plates 144 along the guide inclined surfaces 112 without jamming, ensuring the smoothness of the insertion process and avoiding excessive insertion resistance caused by clamping force. In its natural state, the distance from a lowest point of the curved compression plates 144 to the upper surface of the bottom plate 142 is less than a thickness of the anti-detachment plug-in part 111. When the anti-detachment plug-in part 111 is inserted into the plug-in sockets 14, the anti-detachment plug-in part 111 slides along the guide surface of the curved compression plates 144, the curved compression plates 144 are pushed upwards. The curved compression plates 144 undergoes elastic deformation, thereby applying continuous downward pressure to the anti-detachment plug-in part 111, so that the lower surface of the anti-detachment plug-in part 111 is tightly adhered to the upper surface of the bottom plate 142, thus completely eliminate assembly gaps in the up and down directions to avoid upward and downward movements and abnormal noise of the fan blades 11 during operation.

In this embodiment, an upper side of the plug-in sockets 14 is provided with an installation connection base 13, and a top of the installation connection base 13 is provided with multiple installation screws 131. The installation connection bases 13 with different shapes can be replaced to adapt to the fan blades 11 with different installation angles and improve usability.

The present disclosure further provides an open-leaf fan, including a support body 2 and multiple modular fan blade quick assembly components 1 as described in the first aspect. The support body 2 is internally provided with a motor component 4, and a lower end of the motor component 4 is connected to a rotating seat 3. The plug-in sockets 14 in the modular fan blade quick assembly components 1 are installed in the rotating seat 3 through the installation connection base 13, and the fan blades 11 extend diagonally from a side wall of the rotating seat 3. When the open-leaf fan rotates at high speed, the centrifugal force on the fan blades 11 can be converted into the locking force of the quick assembly component, thereby achieving a tighter self-locking effect as the rotation progresses. At the same time, the redundant design of the double locking blocks 12 ensures that even if one-side locking fails, the other side locking can still ensure that the fan blades 11 will not come out, thereby fundamentally solving the industry safety pain point of centrifugal detachment of the open-leaf fan blades 11 and greatly improving the operational safety of the entire open-leaf fan. The modular fan blade quick assembly components 1 are independent modular structures that can adapt to rotating seats 3 with different specifications of and fan blades 11 with different sizes. When producing the open-leaf fan, there is no need to customize the quick assembly structure separately for different models of products. Only a unified modular quick assembly component is needed to complete the adaptation of the entire series of products, thereby greatly reducing the production cost of the whole machine and shortening the production cycle.

In an implementation mode, the support body 2 is a cylindrical structure with a lifting flange at its top, which is used to fix the lifting flange to a ceiling through expansion bolts. The motor component 4 is fixedly installed in the inner cavity of the support body 2, which adopts a Direct Current, (DC) brushless motor. Its output shaft extends downward and is fixedly connected to a top center of the rotating seat 3, and the rotating seat 3 is driven to rotate horizontally. The rotating seat 3 is a disc-shaped hollow cavity structure, with 5 evenly spaced insertion openings along a circumference on its side wall. And 5 modular fan blade quick assembly components 1 are evenly arranged along the circumference of the rotating seat 3, and are fixed in the inner cavity of the rotating seat 3 by installing the installation screws 131 on the top of the installation connection base 13. The opening of the plug-in sockets 14 of each modular fan blade quick assembly component 1 is opposite to the insertion opening on the side wall of the rotating seat 3. The fan blades 11 are inserted into the plug-in sockets 14 after passing through the insertion opening of the rotating seat 3, and after locking and fixing, the fan blades 11 extend diagonally outward from the side wall of the rotating seat 3. In this embodiment, the on-site installation process of the open-leaf fan is as follows: first, the support body 2 is fixed on the ceiling, the wiring of the motor component 4 is completed, then the five modular fan blade quick assembly components 1 are pre-installed in the rotating seat 3, and then the rotating seat 3 is fixedly connect with the output shaft of the motor component 4. Finally, the five fan blades 11 pass through the insertion opening of the rotating seat 3 and they are inserted into the corresponding plug-in sockets 14 of the modular fan blade quick assembly components 1. After pushing in, the automatic locking can be completed without any tools, and all fan blade installations can be completed with one hand, significantly simplify the on-site installation process. When the open-leaf fan is running, the motor component 4 drives the rotating seat 3 and the fan blades 11 to rotate. The centrifugal force received by the fan blades 11 makes the locking structure of the quick installation component lock tighter and tighter, ensuring safe operation without shaking or abnormal noise, and running smoothly.

In addition, a lower end of the rotating seat 3 is provided with a lighting component 5, which enables the blade fans to have both ventilation and lighting functions, achieving multi-purpose use and improving the practicality and cost-effectiveness of the product. At the same time, the lighting component 5 and motor component 4 can be independently controlled, and the user can turn on the ventilation and lighting functions separately or simultaneously according to their needs, thus providing strong flexibility in use.

In this embodiment, the lower end of the rotating seat 3 is provided with a detachable lighting component 5 through a buckle structure. The lighting component 5 includes circular lamp housing, an light-emitting diode, (LED) lamp board, and a transparent face mask. The LED lamp board is fixed inside the lamp housing, and the transparent face mask is fastened to a lower end of the lamp housing. The power cord of the lighting component 5 is electrically connected to a control board of the motor component 4, and can be independently controlled through a remote control and a wall-controlled switch. An outer diameter of the lighting component 5 is the same as that of the rotating seat 3. After installation, it can completely cover an internal structure of the rotating seat 3, ensuring a simple and beautiful appearance of the whole machine. After disassembling the lighting component 5, the quick installation component inside the rotating seat 3 can be exposed for maintenance and replacement.

This embodiment achieves the decoupling of the quick installation structure and the blade frame structure through independent modular design, adapting to all types of open-leaf fan models and multiple types of blades without the need for repeated mold, thereby greatly reducing manufacturing costs; through the redundant design of dual locking blocks 12 and reverse mechanical self-locking structure, the anti-detachment effect of tightening is achieved, fundamentally solving the safety hazard of centrifugal detachment of fan blades 11; by using structures such as guide inclined surfaces 112 and curved compression plates 144, fast and smooth installation has been achieved, thus completely eliminating assembly gaps and preventing abnormal noises during operation; by using the pull rod part 122 and the out-pull elastic sheets 146, tool free and convenient disassembly and assembly are achieved, which is suitable for maintenance scenarios after ceiling lifting; at the same time, the overall structural components are few, the assembly process is simple, and it is suitable for automated mass production, with extremely high market application value.

It should be noted that all directional indications (such as up, down, left, right, front, back, etc.) in embodiments of the present disclosure are only used to explain the relative position relationship, motion, etc. between components in a specific posture (as shown in the attached figure). If specific posture changes, the directional indication will also change accordingly.

Besides that, a description of “first”, “second”, etc. in the present disclosure is only for descriptive purposes and cannot be understood as indicating or implying their relative importance or implying the number of technical features indicated. Therefore, features that are limited to “first” and “second” can explicitly or implicitly include at least one of these features. In the description of the present disclosure, “multiple” means at least two, such as two, three, etc., unless otherwise specifically limited.

In the present disclosure, unless otherwise specified and limited, terms “connection to”, “connection with”, etc. should be broadly understood. For example, “connection” can be a fixed connection, a detachable connection, or an integrated structure; it can be a mechanical connection or an electrical connection; it can be directly connected or indirectly connected through an intermediate medium, and can be a connection within two components or an interaction relationship between two components, unless otherwise specified. For those skilled in the art, specific meanings of the above terms in the present disclosure can be understood according to a specific situation.

Furthermore, the technical solutions between various embodiments of the present disclosure can be combined with each other, but they must be based on the ability of those skilled in the art to implement them. When the combination of technical solutions is contradictory or impossible to implement, it should be considered that this combination of technical solutions does not exist and is not within the protection scope required by the present disclosure.

What is claimed is:

1. A modular fan blade quick assembly component with redundant self-locking and anti-detachment, comprising: fan blades and plug-in sockets,
wherein one end of the fan blades is provided with an anti-detachment plug-in part configured to insert into one corresponding the plug-in socket, and edges of two sides of the anti-detachment plug-in part are provided with anti-detachment grooves;
interiors of the plug-in sockets that are provided on two sides of the anti-detachment plug-in part are provided with locking blocks that are horizontally rotatable;
when the anti-detachment plug-in part is inserted into the plug-in sockets from an outside, the locking blocks are be pushed to rotate in a first direction; the locking blocks are provided with elastic components configured to drive the locking blocks to rotate in a second direction;
when the anti-detachment plug-in part is inserted into an extreme position and the locking blocks rotate in the second direction, a buckle end provided at one end of the locking blocks is embedded into the corresponding anti-detachment groove.

2. The modular fan blade quick assembly component with redundant self-locking and anti-detachment according to claim 1, wherein another end of the locking blocks is provided with a pull rod part that is configured to extend to outsides of the plug-in sockets.

3. The modular fan blade quick assembly component with redundant self-locking and anti-detachment according to claim 2, wherein each of the anti-detachment grooves comprise a curved side wall and an inclined side wall that are arranged in a V-shape, a circular arc surface of an end of the buckle end is adjacent to the curved side wall, and an adjacent side wall of the buckle end is in contact with the inclined side wall.

4. The modular fan blade quick assembly component with redundant self-locking and anti-detachment according to claim 3, wherein an angle between the inclined side wall and two side walls of the anti-detachment plug-in part is 30 degrees.

5. The modular fan blade quick assembly component with redundant self-locking and anti-detachment according to claim 3, wherein a radius of the curved side wall is 14 mm.

6. The modular fan blade quick assembly component with redundant self-locking and anti-detachment according to claim 5, wherein guide inclined surfaces are provided at corners of two sides of an end of the anti-detachment plug-in part, and when the anti-detachment plug-in part is inserted into the plug-in sockets, the guide inclined surfaces push the locking blocks to rotate in the first direction.

7. The modular fan blade quick assembly component with redundant self-locking and anti-detachment according to claim 6, wherein the end of the anti-detachment plug-in part is centrally provided with a positioning groove, and interiors of the plug-in sockets are provided with a positioning protrusion that is embedded with the positioning groove.

8. The modular fan blade quick assembly component with redundant self-locking and anti-detachment according to claim 7, wherein inner side walls of the plug-in sockets that are on two sides of the positioning protrusion are provided with out-pull elastic sheets, and the out-pull elastic sheets push the fan blades outward after the locking blocks are disengaged from the anti-detachment grooves.

9. The modular fan blade quick assembly component with redundant self-locking and anti-detachment according to claim 8, wherein each of the plug-in sockets comprises a bottom plate and a seat body that is arranged on an upper side of the bottom plate,
the bottom plate and the seat body are connected by multiple threading screws, and middle of the locking blocks are provided with the threading screws as rotating shafts.

10. The modular fan blade quick assembly component with redundant self-locking and anti-detachment according to claim 9, wherein a top of the seat body is provided with multiple curved compression plates that are downward protruding, and the anti-detachment plug-in part contacts the curved compression plates when inserted into the plug-in sockets.

11. The modular fan blade quick assembly component with redundant self-locking and anti-detachment according to claim 9, wherein an upper side of each of the plug-in sockets is provided with an installation connection base, and a top of the installation connection base is provided with multiple installation screws.

12. An open-leaf fan, comprising a support body and multiple modular fan blade quick assembly components according to claim 11, wherein a motor component is provided inside the support body,
a lower end of the motor component is connected to a rotating seat; the plug-in sockets in the modular fan blade quick assembly components are provided in the rotating seat through the installation connection base, and the fan blades extend diagonally from a side wall of the rotating seat.

13. The open-leaf fan according to claim 12, wherein a lower end of the rotating seat is provided with a lighting component.
